(19) United States
(12) Patent Application Publication
(10) Pub. No.: US 2010/0091734 A1
(43) Pub. Date: Apr. 15, 2010

(54) PACKET FORWARDING METHOD IN THE CASE OF THE HANDOVER BETWEEN BASE STATIONS

(75) Inventors: Ji-soo Park, Daejeon-si (KR); Cheol-hye Cho, Daejeon-si (KR); Yeong-jin Kim, Daejeon-si (KR); Young-jick Bahg, Daejeon-si (KR)

Correspondence Address: STAAS & HALSEY LLP, SUITE 700, 1201 NEW YORK AVENUE, N.W., WASHINGTON, DC, 20005, US

(73) Assignees: Electronics and Telecommunications Research Institute, Daejeon-si (KR); Samsung Electronics Co. Ltd, Suwon-si (KR)

(21) Appl. No.: 12/530,730

(22) PCT Filed: Jul. 28, 2008
(86) PCT No.: PCT/KR2008/004393

§ 371 Date: Sep. 10, 2009

(30) Foreign Application Priority Data
Nov. 29, 2007 (KR) 1020070122798

(51) Int. Cl. H04W 36/00

(52) U.S. Cl. 370/331

(57) ABSTRACT

A method for forwarding packets in handover between base stations (eNBs) is provided. A source eNB confirming handover success sends control data indicating an EOD of a forwarding packet to a target eNB when there are no more packets to be forwarded to the target eNB, and the target eNB receiving the control data recognizes from the control data that there are no more packets to be forwarded from the source eNB, thus preventing delay in the handover between the eNBs.

### TECHNICAL FIELD

The present invention relates to a method for forwarding packets in handover between base stations, and more particularly, to a technique of forwarding packets in handover between base stations in a mobile communication system.

This work was supported by the IT R&D program of Ministry of Information and Communication (MIC)/Institute for Information Technology Advancement (IITA) [2005-S-404-23, Research and development on 3G long-term evolution access system].

### BACKGROUND ART

FIG. 1 is a schematic diagram illustrating handover between base stations (i.e., evolved Node Bs (eNBs)) in a 3rd Generation Partnership Project (3GPP) Long Term Evolution (LTE) mobile communication system, in which as a user equipment (UE) moves, handover occurs from a source eNB to a target eNB.

In the handover between the eNBs in the LTE mobile communication system, an eNB to be currently accessed by the UE is defined as a source eNB, and a new base station targeted for handover is defined as a target eNB.

The eNB provides a radio interface, such as a radio link, a radio channel, or a radio bearer so that UE accesses to the LTE mobile communication system, controls and manages radio resource allocation and release to the UE, and transfers user data.

The eNB includes radio protocols, such as Packet Data Convergence Protocol (PDCP) for transmitting and receiving user packet data, Radio Link Control (RLC), Media Access Control (MAC), and Physical (PHY) layer protocol in order to perform header compression, ciphering, packet scheduling, Automatic Repeat Request (ARQ) and Hybrid ARQ (HARM), and the like.

In particular, a PDCP entity of a PDCP layer performs, on user plane (U-plane) data, header compression, transmission of user data between an upper Non-Access Stratum (NAS) layer and a lower RLC layer, sequential delivery of upper layer data in handover, duplication detection for lower layer data, and ciphering; and on control plane (C-plane) data, ciphering and integrity protection, and transmission and reception of the C-plane data between an upper RRC layer and a lower RLC layer.

With conventional techniques, it is difficult to recognize an End Of Data (EOD) of a packet forwarded from a source eNB in handover between eNBs. So, in order to obtain the EOD, a timer or a signaling message, such as a control signal, that is sent to indicate that there are no more packets to be forwarded, is used.

These cause delay in handover between eNBs for large-capacity multimedia service such as Video On Demand (VOD) requiring high transmission speed.

Also, limited buffering of packets received from a serving gateway in a target eNB, caused by a delay in determining whether a packet is a last one, may cause packet overflow and, in turn, loss of downlink packets, resulting in low-quality handover.

In order to resolve the aforementioned problems, there is a need for a packet forwarding technique that is free of packet loss and stabilized in handover.

### DISCLOSURE OF INVENTION

### Technical Problem

The present inventor has studied a technique capable of preventing loss of packets in a queue of a target eNB and unnecessary delay of the packets for high-speed packet forwarding when downlink and uplink packets are forwarded from a source eNB to the target eNB, by enabling the target eNB to recognize that there are no more packets to be forwarded using a data format indicating an EOD of a packet forwarded from the source eNB, instead of using a timer or depending on a result of sending a signaling message such as a control signal in the handover between the eNBs.

The present invention discloses a method for forwarding packets in handover between base stations (eNBs) that is capable of quickly and stably forwarding packets without queuing by providing a data format indicating an EOD of a packet forwarded from a source eNB so that a target eNB recognizes that there are no more packets to be forwarded in the handover between the eNBs.

### Technical Solution

According to an aspect of the present invention, the present invention is characterized in that a source eNB confirming handover success sends control data indicating an EOD of a forwarding packet to a target eNB when there are no more packets to be forwarded to the target eNB, and the target eNB receiving the control data recognizes from the control data that there are no more packets to be forwarded from the source eNB.

Additional features of the invention will be set forth in the description which follows, and in part will be apparent from the description, or may be learned by practice of the invention.

### Advantageous Effects

According to the present invention, in a handover between eNBs, a data format indicating an EOD of a packet forwarded from a source eNB is provided so that a target eNB recognizes that there are no more packets to be forwarded. This can prevent delay in the handover between the eNBs and loss of downlink packets caused by packet overflow due to limited buffering caused by a delay in determining whether a packet is a last one, thus guaranteeing quality of service.

### BRIEF DESCRIPTION OF THE DRAWINGS

The accompanying drawings, which are included to provide a further understanding of the invention and are incorporated in and constitute a part of this specification, illustrate embodiments of the invention, and together with the description serve to explain the principles of the invention.

FIG. 1 is a schematic diagram illustrating handover between base stations (eNBs) in a Long Term Evolution (LTE) mobile communication system;

FIG. 2 is a flowchart illustrating a control plane (C-plane) signal processing procedure in handover in an LTE mobile communication system;

FIGS. 3 to 6 are flowcharts illustrating a user plane (U-plane) data processing procedure in handover in an LTE mobile communication system;

FIG. 7 is a flowchart illustrating a method for forwarding packets in handover between eNBs according to an exemplary embodiment of the present invention;

FIG. 8 illustrates a structure of control data sent between a source eNB and a target eNB in handover between eNBs according to the present invention;

FIG. 9 illustrates a structure of user data sent between a source eNB and a target eNB in handover between eNBs according to the present invention; and

FIGS. 10 to 12 are C-plane signal processing procedures in handover in an LTE mobile communication system.

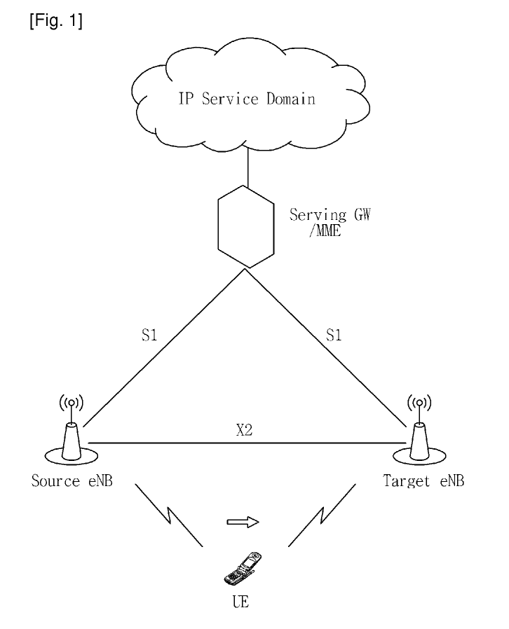

### MODE FOR THE INVENTION

The invention is described more fully hereinafter with reference to the accompanying drawings, in which exemplary embodiments of the invention are shown. This invention may, however, be embodied in many different forms and should not be construed as limited to the embodiments set forth herein. Rather, these embodiments are provided so that this disclosure is thorough, and will fully convey the scope of the invention to those skilled in the art.

A 3GPP LTE system is a new version of a packet-based UMTS system, including an evolved UTRA and a Universal Terrestrial Radio Access Network (UTRAN), that is an asynchronous mobile communication system. The 3GPP LTE system guarantees a round-trip time as low as 10 ms or less, a downlink data rate as high as 100 Mbps, and an uplink data rate as high as 50 Mbps, and uses a packet switched network rather than an existing circuit switched network with low efficiency of network resources, so that a Packet Data Network (PDN) and UE easily cooperate with each other. Radio access technology has been standardized.

In particular, a network constituting the LTE system is a combination of an Evolved Packet Core (EPC) network for connecting a radio access network to a foreign network and an EUTRAN. The UE can receive high-speed IP-based service by accessing the LTE system via nodes of these networks. Here, the combination of the EPC and the EUTRAN is made via an S1 interface, and a combination between the eNBs in the EUTRAN is made in a meshed network structure via an X2 interface.

Network elements of the EPC network include a system architecture evolution access gateway having a gateway function for a connection between an IP-based wired network and a radio access network, packet routing and forwarding, and a connection to an external PDN; and a Mobility Management Entity (MME) for performing UE mobility management and UE authentication, bearer and session management, and Non-Access Stratum (NAS) signaling control.

The access gateway includes a PDN gateway having a gateway function for the connection to the external PDN, and a serving gateway for performing an IP-based connection between a radio access network and a wired network through match with the LTE system, and packet routing and forwarding.

Network elements of the EUTRAN network include eNB nodes for providing a radio access interface for radio transmission and reception between UEs in one or more cells, and performing radio resource management and control, and data transmission and processing through radio transmission and reception between the UEs. The eNB performs a radio access function incorporating original functions of an RNC in a UTRAN, which is a radio access network for an existing 3rd generation UMTS, and a Node B.

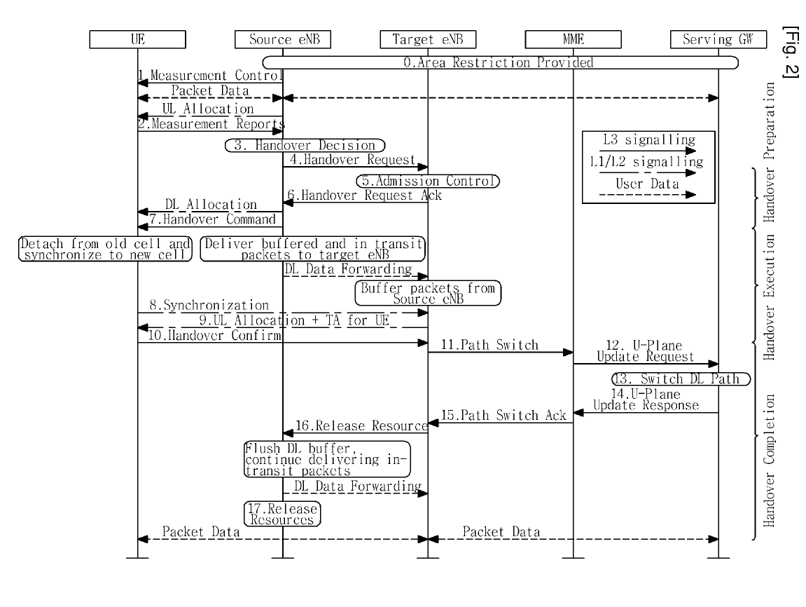

FIG. 2 is a flowchart illustrating a control plane (C-plane) signal processing procedure in handover in an LTE mobile communication system. C-plane signal processing in handover in an LTE mobile communication system is involved in only a user data path switching procedure.

(C-plane)-1. Measurement Control

A source eNB forms a UE measurement procedure according to area restriction information. Measurements provided by the source eNB assist in controlling UE connection mobility.

(C-plane)-2. Measurement Report

When radio resources for forwarding uplink (UL) data are allocated from the source eNB, the UE sends a measurement report message to the source eNB.

(C-plane)-3. Handover Decision

Upon receipt of the measurement report message from the UE, the source eNB decides whether UE handover is to occur, based on Radio Resource Management (RRM) information.

(C-plane)-4. Handover Request

After determining that the UE handover is to occur, the source eNB sends a handover request message to a target eNB.

The message includes information required for handover preparation, such as UE X2 signaling context reference at a source eNB side, UE S1 EPC signaling context reference, a target cell ID, an RRC context including a C-RNTI of a UE in the source eNB, Access Stratum (AS)-configuration for radio protocols corresponding to radio layers 2 and 3, a physical layer ID corresponding to System Architecture Evolution (SAE) Bearer context and source cell+Media Access Control (MAC), and the like.

The target eNB records destination information for the source eNB and the EPC, based on the UE X2/UE S1 signaling reference information. The SAE bearer context includes Radio Network Layer (RNL)/Transport Network Layer (TNL) destination information, and a Quality of Service (QoS) profile of the SAE Bearer.

(C-plane)-5. Call Admission Control

If the radio resources are available, the target eNB performs call admission control to increase a likelihood of successful handover through the received QoS information of the SAE bearer.

The target eNB configures resources requested by the received QoS information of the SAE bearer. AS-configuration of the target eNB may be configured by bearer re-configuration which requires some modifications as compared to the configuration of the source eNB, or may be newly independently configured, for example, by something such as an Establishment procedure.

(C-plane)-6. Handover Request ACK

The target eNB prepares handover with radio layers 1 (L1) and 2 (L2) configured as above, and sends a handover request ACK message to the source eNB.

This message includes part of handover command information to be sent to the UE, as a transparent container. The container may include a new C-RNTI and a dedicated Random Access Channel (RACH) preamble, an expiry time indication, and parameters, such as an access parameter and information on SIBs.

The handover request ACK message may include RNL/TNL information for a forwarding tunnel between the source eNB and the target eNB, if necessary.

In this case, the source eNB may forward the downlink data to the target eNB as soon as it receives the handover request ACK message or sends a handover command to the UE.

(C-plane)-7. Handover Command

The source eNB creates a handover command message as a Radio Resource Control (RRC) message and sends the same to the UE. The handover command message includes the transparent container received from the target eNB. The source eNB performs integrity protection and ciphering on the message. The UE receives the handover command message and recognizes the command to perform a handover procedure.

(C-plane)-8. Synchronization

The UE then performs synchronization with the target eNB, and accesses the target cell via the RACH.

(C-plane)-9. UL Allocation

An access network responds through UL allocation and Timing Advance (TA).

(C-plane)-10. Handover Confirm

When the UE successively connects to the target cell, the UE sends a handover confirm message to the target eNB to indicate that the UE has completed the handover procedure. The target eNB verifies C-RNTI included in this message, and begins to forward the downlink data packet to the UE when the C-RNTI is verified.

(C-plane)-11. Path Switch

After receiving the handover confirm message, the target eNB sends a path switch message to a Mobility Management Entity (MME) to indicate that the UE, which has performed the handover procedure, has changed the cell.

(C-plane)-12. U-plane updated request

Upon receipt of the path switch message, the MME sends a U-plane updated request message to the serving gateway.

(C-plane)-13. Switch Downlink Path

The serving gateway switches a U-plane path, i.e., a downlink data path to the target eNB, and releases TNL resources for the U-plane directed to the source eNB.

(C-plane)-14. U-plane Updated Response:

After switching the path, the serving gateway sends a U-plane updated response message to the MME.

(C-plane)-15. Path Switch ACK

The MME sends a path switch ACK message to the target eNB to acknowledge the reception of the path switch message.

(C-plane)-16. Resources Release 1

After confirming the path switch, the target eNB sends a resources release message to the source eNB to indicate handover success, and triggers the source eNB to release existing resources.

(C-plane)-17. Release Resource 2

Upon receipt of the resources release message, the source eNB releases radio resources pertaining to the UE context and resources pertaining to the C-plane.

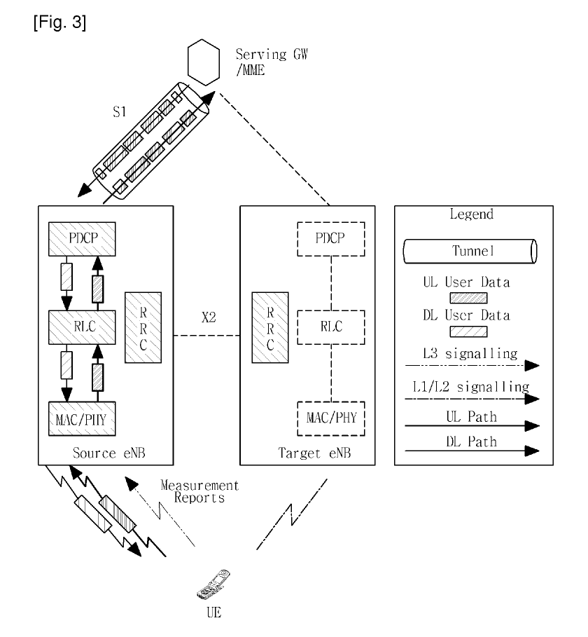

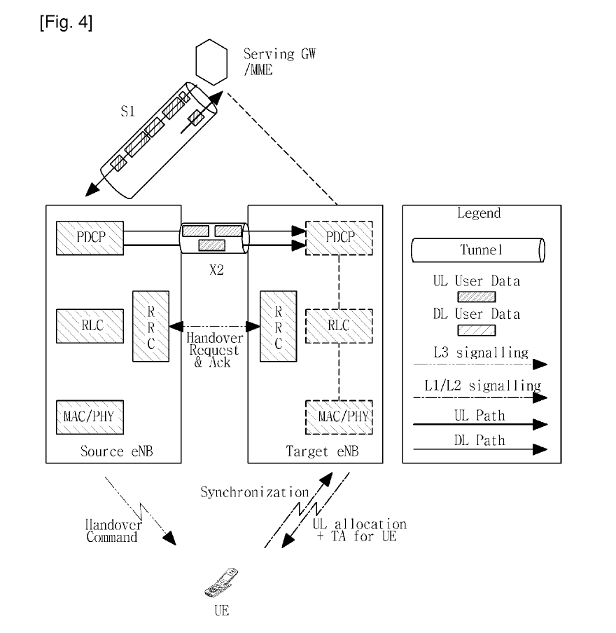

FIGS. 3 to 6 are flowcharts illustrating a U-plane data processing procedure in handover in an LTE mobile communication system.

(U-plane)-1. Neighbor Cell Detection

(U-plane)-1 is a U-plane data processing procedure that corresponds to the C-plane signal processing procedure in (C-plane)-1 to (C-plane)-3 shown in FIG. 2. Referring to FIG. 3, a normal state is maintained in which a data path for transmission and reception of uplink and downlink packet data is unchanged.

(U-plane)-2. Handover Preparation & Execution

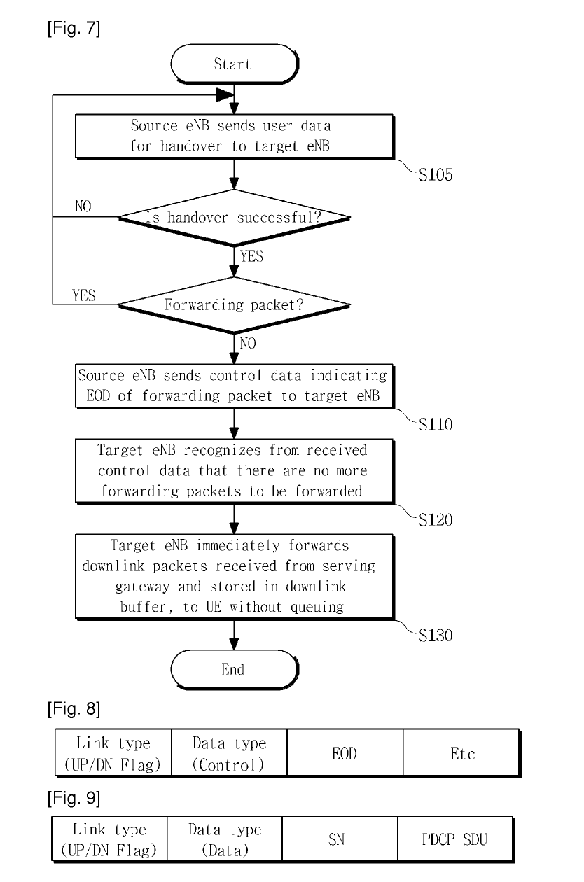

(U-plane)-2 is a U-plane data processing procedure that corresponds to the C-plane signal processing procedure in which the source eNB determines whether the handover is to occur in (C-plane)-3 shown in FIG. 2 and sends the handover command message in (C-plane)-4 to (C-plane)-7. Referring to FIG. 7, when the handover request ACK message is received in (C-plane)-6, a copy of the packet forwarded from the serving gateway to the source eNB is stored in a downlink buffer.

When a U-plane tunnel for downlink data forwarding is established via an X2 interface, the source eNB sequentially forwards the downlink data packets to the target eNB as long as the source eNB receives packets from the serving gateway of the EPC or the downlink buffer of the source eNB is not empty.

The target eNB stores the forwarding packets received from the source eNB in the forwarding buffer until the UE completes handover preparation, that is, the target eNB receives the handover confirm message from the UE in the (C-plane)-10.

In this case, the forwarding packet of user data is a Packet Data Convergence Protocol (PDCP) Service Data Unit (SDU) having a sequence number (SN). Downlink data forwarding is performed on all packets of which the reception has not been acknowledged by the ARQ of the RLC from the UE among the downlink packets or on packets that have not been normally forwarded to the UE through HARQ feedback information. An SDU packet forwarding scheme may be determined depending on eNB implementations.

For uplink, the source eNB upon the handover forwards an uplink PDCP SDU with a correct sequence successfully received from the UE to the serving gateway (Serving GW) and forwards a PDCP SDU with a PDCP SN out of sequence among the packets received from the UE, to the target eNB.

The UE re-forwards the PDCP SDU packet of which the successful reception has not been acknowledged by the source eNB, to the target eNB.

(U-plane)-3. Handover Completion 1

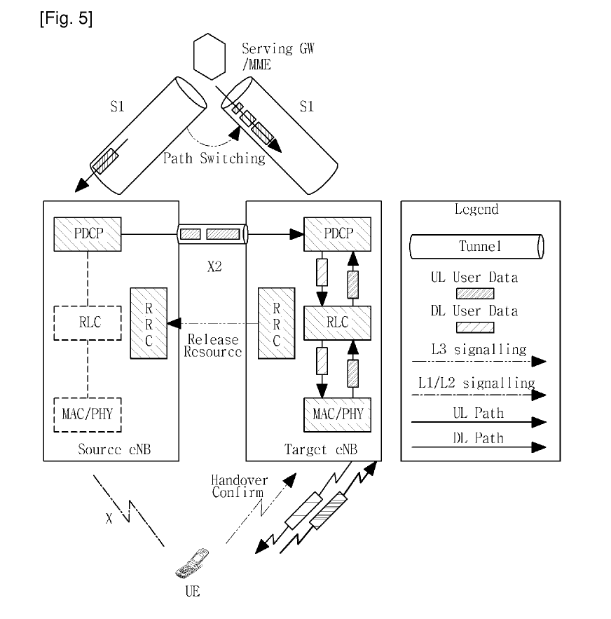

(U-plane)-3 is a U-plane data processing procedure that corresponds to the C-plane signal processing procedure in which the resources release message is sent from the target eNB to the source eNB in (C-plane)-10 to (C-plane)-17 shown in FIG. 2. Referring to FIG. 5, upon receipt of the handover confirm message indicating handover completion from the UE in (C-plane)-10, the target eNB begins to forward to the UE the downlink forwarding packets, which are received via the X2 interface and stored in the forwarding buffer.

In this case, the target eNB exchanges state information for sequential delivery of

PDCP packets and detection of duplicate packets with respect to the downlink packet with the UE through PDCP control (control packet). (The downlink packet transmission path from the serving gateway is not yet switched).

Upon receipt of the path switch ACK message in (C-plane)-15, the target eNB begins to forward all the forwarding packets received from the source eNB to the UE. Thereafter, downlink packets received via the S1 path switched by path switch are stored in a separate downlink buffer, unlike the forwarding packets. In this case, the forwarding packets received from the source eNB may be preferentially retransmitted to the UE.

The target eNB forwards all the forwarding packets, and then begins to forward the downlink packets received via the switched S1 path, to the UE. Upon receipt of the path switch ACK, the target eNB immediately indicates handover success by delivering a resource release message to the source eNB in order to release resources for an existing bearer. After confirming the success, the source eNB deletes from the buffer all the downlink data that it has forwarded to the target eNB, but continues to forward the downlink packets received through the existing bearer, to the target eNB, as long as the source eNB receives the packets from the serving gateway of the EPC.

(U-plane)-4. Handover Completion 2

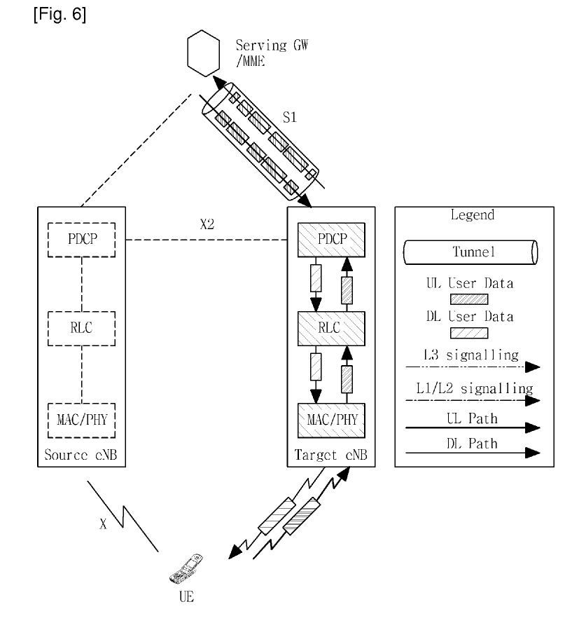

(U-plane)-4 is a U-plane data processing procedure that corresponds to the C-plane signal processing procedure following the resources release in (C-plane)-17 shown in FIG. 2. Referring to FIG. 6, all existing paths for the source eNB are disconnected and mobile communication service is provided in which uplink and downlink packets are transmitted and received between the UE and the network via a new bearer for the target eNB.

As described above, the source eNB forwards the downlink handover packet from the serving gateway to the target eNB during the handover between the eNBs. And, a series of procedures, including recognizing a time when path switch occurs between the serving gateway and the eNB as the packets are forwarded, and managing the forwarding packet buffer in the eNB, are performed until the handover is completed. According to the present invention, a data format indicating an EOD of the packet forwarded from the source eNB is provided in the handover between the eNBs, so that the target eNB recognizes that there are no more packets to be forwarded. This allows fast and stable packet forwarding without queuing in the handover between the eNBs.

FIG. 7 is a flowchart illustrating a method for forwarding packets in handover between eNBs according to an exemplary embodiment of the present invention. The method for forwarding packets in handover between eNBs according to this exemplary embodiment can prevent loss of packets in a queue in the target eNB and unnecessary packet delay for high-speed packet forwarding when the source eNB forwards the packets to the target eNB in the handover between the eNBs.

First, when there are no packets to be forwarded to the target eNB, the source eNB confirming the handover success sends control data indicating an EOD of the forwarding packet to the target eNB in S110.

An example of the control data indicating an EOD of the forwarding packet is shown in FIG. 8. Referring to FIG. 8, the control data indicating an EOD of the forwarding packet includes link type information (UP/DN flag) indicating whether the forwarding packet is an uplink one or a downlink one, data type information indicating control data, and End Of Data (EOD) information indicating that a previous forwarding packet is a last one. The control data may further include additional information (Etc) for the purpose of control.

After receiving the control data indicating an EOD of the forwarding packet in S110, the target eNB recognizes from the control data that there are no more forwarding packets to be forwarded from the source eNB in S120.

That is, after receiving the control data indicating an EOD of the forwarding packet, the target eNB determines based on the link type information whether the forwarding packet is a downlink PDCP SDU packet sent from the serving gateway in the network or an uplink PDCP SDU packet sent from the UE. The PDCP SDU packet refers to a data packet communicated between an upper NAS layer and a lower PDCP layer.

The target eNB recognizes, from the data type information, that the control data is for control and, from the EOD information, that the previous forwarding packet is a last one.

After recognizing, from the data type information, that the control data is for control and, from the EOD information, that the previous forwarding packet is a last one, the target eNB performs prescribed control operation or control operation indicated by the control information (Etc).

According to further aspects of the present invention, the control operation, which is performed by the target eNB recognizing from the EOD information that a previous forwarding packet is a last one, may be downlink packet processing.

After recognizing in S120 that there are no more packets to be forwarded from the source eNB, the target eNB immediately forwards the downlink packets received from the serving gateway and stored in the downlink buffer, to the UE without queuing in S130. In this case, the target eNB may eliminate the forwarding buffer used for the handover.

By doing so, in the handover between the eNBs, the target eNB can recognize that there are no more packets to be forwarded, from the control data indicating an EOD of a packet forwarded from the source eNB, thus allowing fast and stable packet forwarding without queuing.

Meanwhile, according to further aspects of the present invention, the method for forwarding packets in handover between eNBs according to the present invention may further include, before S110, sending user data for handover from the source eNB to the target eNB (S105).

An example of the user data for handover is shown in FIG. 9. Referring to FIG. 9, the user data for handover includes link type information (UP/DN flag) indicating whether a forwarding packet is an uplink one or a downlink one, data type information indicating handover data, Sequence Number (SN) information indicating an SN, and PDCP SDU information indicating data received from the UE in the case of uplink and indicating data received from the NAS in the case of downlink, the data not being modified, for example, header compressed.

After receiving the user data for handover, the target eNB determines whether the forwarding packet is a downlink PDCP SDU packet forwarded from the serving gateway in the network or an uplink PDCP SDU packet forwarded from the UE based on the link type information. The PDCP SDU refers to a data packet communicated between an upper NAS layer and a lower PDCP layer.

The target eNB recognizes from the data type information that the user data is intended to forward the PDCP SDU packet including the SN, and recognizes a sequence of the packet, the SN, from the SN information. The PDCP SDU information includes uplink or downlink data.

After recognizing from the data type information that the user data is intended to forward the PDCP SDU packet, the target eNB forwards the data included in the PDCP SDU information in an uplink or downlink direction recognized from the link type information.

In this case, the source eNB sequentially configures the PDCP SDUs including an SN among the downlink packets received from the serving gateway, in a user data format, and then forwards the same to the target eNB in S105.

Meanwhile, the source eNB configures a PDCP SDU having an SN out of sequence among the uplink packets received from the UE, in the user data format, and then sends the same to the target eNB in S105.

Thus, according to the present invention, the packet for handover sent between the source eNB and the target eNB in the handover between the eNBs is defined and used as the above user data format, which prevents delay in the target eNB managing the buffer and processing uplink/downlink packets depending on purposes of use of the packets.

An example in which the method for forwarding packets in handover between base eNBs according to the present invention is applied to the U-plane shown in FIGS. 3 to 6 will now be described.

For example, the method for forwarding packets in handover between eNBs according to the present invention is applied to the U-plane data processing procedure (U-plane)-2 (see FIG. 7). When a copy of the PDCP SDU including SN header forwarded from the serving gateway is stored in a downlink buffer (DnBf) of the source eNB and a U-plane tunnel is established via the X2 interface for downlink data forwarding, the source eNB sequentially configures the downlink data packets, which are the PDCP SDUs including an SN, in the user data format shown in FIG. 9, and forwards the same to the target eNB, as long as the source eNB receives the packets from the serving gateway of the EPC or the downlink buffer (DnBf) of the source eNB is not empty.

In this case, the link type information (UP/DN flag) is set to ‘DN’ indicating a downlink, and the data type information is set to ‘Data’ indicating user data for handover, and the SN information is set to a sequence number of a next packet to be received by the UE.

The target eNB stores the forwarding packets received from the source eNB in the forwarding buffer (FwBf) until the UE completes the handover preparation, that is, the target eNB receives the handover confirm message from the UE in the C-plane signal processing procedure (C-plane)-10.

In this case, the forwarding packet of the user data is a PDCP SDU having an SN. Downlink data forwarding is performed on all packets of which the reception has not been acknowledged by the ARQ of the RLC from the UE among the downlink packets or on packets that have not been normally forwarded to the UE through hyper ARQ (HARQ) feedback information. An SDU packet forwarding scheme may be determined depending on eNB implementations.

For uplink, the source eNB upon the handover forwards an uplink PDCP SDU with a correct sequence successfully received from the UE to the serving gateway, and configures a PDCP SDU with a PDCP SN out of sequence among the packets received from the UE, in a user data format shown in FIG. 9 and then forwards the same to the target eNB.

In this case, the link type information (UP/DN flag) is set to ‘UP’ indicating an uplink, the data type information is set to ‘Data’ indicating user data for handover, and the SN information is set to an SN received from the UE.

Also, the UE forwards the PDCP SDU packet of which the successful reception has not been acknowledged by the ARQ or HARQ of the RLC from the source eNB, to the target eNB.

That is, according to the present invention, the user data for handover transmitted and received between the source eNB and the target eNB is used in the format defined in FIG. 9, so that the PDCP entity of the target eNB easily identifies that the received packet is a downlink PDCP SDU received from the serving gateway due to handover or an uplink packet received from the UE and the PDCP entity easily handles the PDCP SDU packet in managing the buffer management and processing uplink/downlink packets depending on purposes of use.

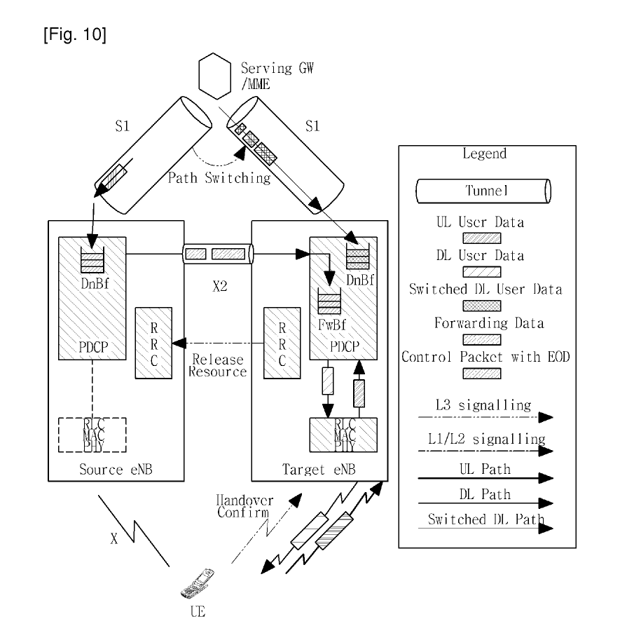

An example in which the method for forwarding packets in handover between eNBs according to the present invention is applied to the C-plane shown in FIG. 2 will now be described with reference to FIGS. 10 to 12. FIGS. 10 to 12 illustrate processes for delivering the control data shown in FIG. 8 to the target eNB including forwarding and downlink buffers according to a basic handover scenario sequence.

FIG. 10—Handover Completion A

This is a U-plane data processing procedure that corresponds to a part of the C-plane signal processing procedure in which the resources release message is sent from the target eNB to the source eNB in (C-plane)-10 to (C-plane)-14 as shown in FIG. 2.

Upon receipt of the handover confirm message from the UE indicating that the handover in (C-plane)-10 is completed, the target eNB begins to preferentially forward the downlink forwarding packets, which have been received via the X2 interface and stored in the forwarding buffer (FwBf), to the UE.

Upon receipt of the path switch ACK message in (C-plane)-15, the target eNB stores the downlink packets received via the Si path switched by path switch in a separate downlink buffer (DnBf) until the target eNB preferentially forwards all forwarding packets having a priority to the UE to guarantee sequential delivery of PDCP SDU packets of the upper layer.

After receiving the path switch ACK message, the target eNB indicates handover success and path switch completion by sending the resources release message to the source eNB to release resources for an existing bearer.

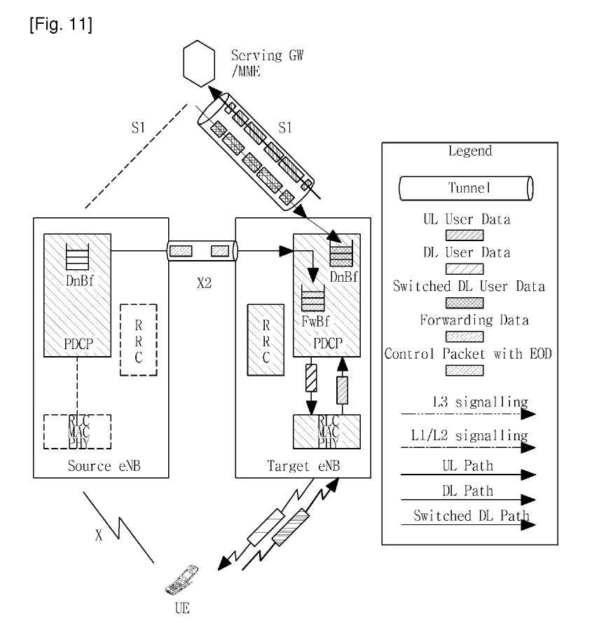

FIG. 11—Handover Completion B

After performing the procedure of the handover completion A and then confirming the handover success, the source eNB deletes all the packets from the downlink buffer (DnBf) of which the transmission has been completed, does not store packets received from the serving gateway in the buffer, and continues to forward the downlink data to the target eNB as long as there is downlink data forwarded to the target eNB.

Immediately after confirming that a tunnel of an existing Transport Network Layer (TNL) has been eliminated prior to the PDCP being released and when there are no packets to be forwarded to the target eNB, the source eNB configures the control packet in the control data format shown in FIG. 8 in order to indicate that there are no more packets to be forwarded to the target eNB and a previously forwarded packet is a last one (EOD).

In this case, the link type information (UP/DN flag) is set to ‘DN’ indicating a downlink, and the data type information is set to ‘Control’ indicating control data, followed by End-Of-Data (EOD) information.

When the received forwarding packet is a data packet including a PDCP SDU, the target eNB stores the packet in the forwarding buffer (FwBf) and stores the downlink packet from the serving gateway in the downlink buffer (DnBf).

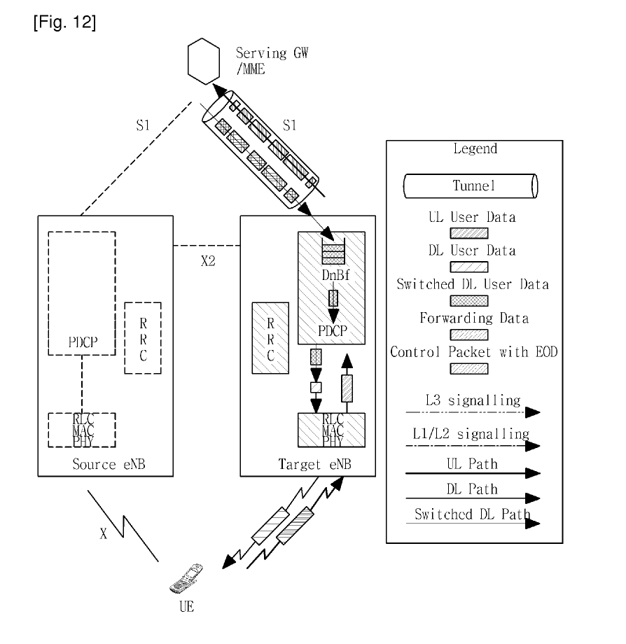

FIG. 12—Handover Completion C

Following the procedure of the handover completion B, when the forwarding packet received by the target eNB is a last one, i.e., control data including the EOD information as shown in FIG. 8, it means that all the downlink packets in the forwarding buffer (FwBf) have been forwarded. Accordingly, the downlink packets stored in the downlink buffer (DnBf) begin to be forwarded without delay, and the packets are deleted from the forwarding buffer (FwBf) used in the handover.

According to the present invention, the signal indicating that data is a last one is sent from the source eNB to the target eNB upon forwarding the downlink data. Also, the target eNB can forward the downlink forwarding data stored in the forwarding buffer (FwBf) or PDCP SDU data forwarded without use of the buffer, and then, forward packets received from the serving gateway and stored in the downlink buffer (DnBf) immediately after forwarding the forwarding packets, without use of a timer. Thus, the forwarding packets can be fast forwarded to the UE without delay caused by unnecessary queuing in packet forwarding.

Furthermore, the target eNB immediately forwards the downlink packets received from the serving gateway without unnecessary packet queuing, thereby preventing loss of packets input to the downlink buffer (DnBf) due to its limited size and reducing the size of the buffer.

In particular, the present invention can resolve problems of packet loss and delay by being applied to suppress transmission delay in real-time voice and moving picture communication service and to large-capacity multimedia service such as VOD necessitating several tens of Mbps and high transmission speed.

The present invention can be applied to a variety of systems such as a Long Term Evolution (LTE) mobile communication system and a Legacy Universal Mobile Telecommunication Service (Legacy UMTS) system. Also, the present invention can be applied to handover between the LTE and a legacy system such as the UMTS to achieve efficient system combination and shortened delay of downlink packet transmission through efficient packet and buffer management.

It will be apparent to those skilled in the art that various modifications and variation can be made in the present invention without departing from the spirit or scope of the invention. Thus, it is intended that the present invention cover the modifications and variations of this invention provided they come within the scope of the appended claims and their equivalents.

### INDUSTRIAL APPLICABILITY

The present invention can be efficiently applied to the field of a technique of forwarding packets in handover between eNBs and of its applications.

1. A method for forwarding packets from a source base station (eNB) to the target eNB in handover between the eNBs, comprising:
sending, by the source eNB confirming handover success, control data indicating an EOD of a forwarding packet to the target eNB when there are no more packets to be forwarded to the target eNB; and
recognizing, by the target eNB receiving the control data indicating an EOD of a forwarding packet, from the control data that there are no more packets to be forwarded from the source eNB.

2. The method of claim 1, further comprising immediately forwarding, by the target eNB recognizing that there are no more packets to be forwarded, downlink packets received from a serving gateway and stored in a downlink buffer, to a user equipment (UE) without queuing.

3. The method of claim 2, wherein the target eNB eliminates a forwarding buffer used for handover.

4. The method of claim 3, further comprising sending, by the source eNB, user data for handover to the target eNB prior to the sending of the control data.

5. The method of claim 4, wherein the source eNB sequentially configures Packet Data Convergence Protocol (PDCP) Service Data Units (SDUs) including a Sequence Number (SN) among downlink packets received from the serving gateway, in a user data format, and forwards the same to the target eNB.

6. The method of claim 5, wherein the source eNB sequentially configures PDCP SDUs including an SN out of sequence among uplink packets received from the UE, in the user data format, and forwards the same to the target eNB.

7. The method of claim 1, wherein the control data indicating an EOD of a forwarding packet includes:
link type information indicating whether the forwarding packet is an uplink one or a downlink one;
data type information indicating control data; and
End Of Data (EOD) information indicating that a previous forwarding packet is a last one.

8. The method of claim 4, wherein the user data for handover comprises:
link type information indicating whether the forwarding packet is an uplink one or a downlink one;
data type information indicating handover data;
SN information indicating an SN; and
PDCP SDU information indicating data received from the UE in the case of uplink and indicating unmodified data received from a Non-Access Stratum (NAS) in the case of downlink.

9. A computer-readable recording medium having control data stored thereon, the control data indicating an EOD of a forwarding packet and comprising:
link type information indicating whether the forwarding packet is an uplink one or a downlink one;
data type information indicating control data; and
EOD information indicating that a previous forwarding packet is a last one.

10. A computer-readable recording medium having user data for handover stored thereon, the user data for handover comprising:
link type information indicating whether the forwarding packet is an uplink one or a downlink one;
data type information indicating handover data;
SN information indicating an SN; and
PDCP SDU information indicating data received from a UE in the case of uplink and indicating unmodified data received from the NAS in the case of downlink.
